(19) United States
(12) Patent Application Publication
(10) Pub. No.: US 2026/0261005 A1
(43) Pub. Date: Sep. 3, 2026

(54) CAP ASSEMBLY, RECHARGEABLE BATTERY INCLUDING THE CAP ASSEMBLY, AND METHOD OF MANUFACTURING THE RECHARGEABLE BATTERY

(71) Applicant: SAMSUNG SDI CO., LTD., Yongin-si (KR)

(72) Inventor: Iloh SON, Yongin-si (KR)

(21) Appl. No.: 19/278,977

(22) Filed: Jul. 24, 2025

(30) Foreign Application Priority Data
Jan. 3, 2025 (KR) 10-2025-0001140

(51) Int. Cl. H01M 50/367; H01M 50/152; H01M 50/16

(52) U.S. Cl. CPC H01M 50/367; H01M 50/152; H01M 50/16

(57) ABSTRACT

A rechargeable battery includes a case including a bottom portion, a lateral portion extending from an edge of the bottom portion, and a bead portion in which the lateral portion is recessed toward an inside of the case. An electrode assembly is accommodated in the case, with the electrode assembly including a first electrode, a second electrode, and a separator disposed between the first electrode and the second electrode. A cap assembly is coupled to the case. The cap assembly includes a vent plate, an upper cap portion arranged on the vent plate, and a coupling portion arranged opposite to the upper cap portion with the vent plate therebetween. The coupling portion includes a groove in which the bead portion is received.

### CROSS-REFERENCE TO RELATED APPLICATION

This application claims priority to and the benefit of Korean Patent Application No. 10-2025-0001140 filed with the Korean Intellectual Property Office on Jan. 3, 2025, the entire contents of which are incorporated herein by reference.

### BACKGROUND OF THE DISCLOSURE

### (a) Field of the Disclosure

The present disclosure relates to a cap assembly, a rechargeable battery including the cap assembly, and a method of manufacturing the rechargeable battery.

### (b) Description of the Related Art

A rechargeable battery may be classified as cylindrical, prismatic, and pouch-types depending its shape. In a cylindrical or prismatic rechargeable battery, an electrode assembly is housed in a case with one open end. In a pouch-type rechargeable battery, the electrode assembly is built into a case made of laminate film or plastic.

In a cylindrical rechargeable battery, beading work may be performed to shape a portion of an upper part of the case to prevent movement of the electrode assembly after inserting the electrode assembly into the case. After the beading work, a cap assembly may be placed on an area where a beading portion is formed, and the position of the cap assembly may be fixed through crimping work that bends the end of the case.

The cap assembly and the electrode assembly may be disposed apart from each other with a recessed bead portion of the case interposed between the cap and electrode assemblies. In this configuration, excess space may be present between the cap assembly and the electrode assembly.

The information disclosed in this section is intended to improve understanding of the background of the present disclosure and may therefore include information that does not constitute conventional or prior art.

### SUMMARY OF THE DISCLOSURE

The present disclosure provides a rechargeable battery including a cap assembly for efficiently using internal space of a case.

The present disclosure provides a cap assembly for the rechargeable battery.

The present disclosure provides a method of manufacturing a rechargeable battery.

Technical objects of the present disclosure are not limited to the above-described technical objects, and other technical objects will be clearly comprehended by a person of ordinary skill in the art in view of the present disclosure.

An embodiment of the present disclosure provides a rechargeable battery including: a case including a bottom portion, a lateral portion extending from an edge of the bottom portion, with the lateral portion including a bead portion that is recessed toward an inside of the case; an electrode assembly accommodated in the case, the electrode assembly including a first electrode, a second electrode, and a separator disposed between the first electrode and the second electrode; and a cap assembly coupled to the case, wherein the cap assembly includes a vent plate, an upper cap portion arranged on the vent plate, and a coupling portion arranged opposite to the upper cap portion with the vent plate therebetween, the coupling portion having a groove in which the bead portion is received.

The coupling portion may include a lower cap portion and an elastic lower plate, with the groove being formed by the lower cap portion and the lower plate.

The lower plate may be more elastic than the lower cap portion.

The lower plate may be made of polyethylene (PE) or polypropylene (PP).

A first opening is formed in the lower cap portion, a second opening is formed in the lower plate, with a second opening being aligned with the first opening, and a first electrode tab electrically connected to the first electrode may pass through the first opening and the second opening and may be electrically connected to the vent plate.

The cap assembly may further include an insulation member for preventing electric short-circuit between the first electrode and the second electrode, and the insulation member may include a first portion arranged between the vent plate and the lower cap portion, and a second portion having a side connected to the first portion, with the second portion being arranged between the vent plate and the lateral portion.

The case may further include a crimping portion at an end of the lateral portion, the crimping portion being bent toward the cap assembly, and the insulation member may further include a third portion connected to a second side of the second portion and arranged between the upper cap portion and the crimping portion.

The lower cap portion may include a first center portion and a first wing portion extending from an edge of the first center portion, with the first wing portion being bent in a direction toward the vent plate, the lower plate may include a second center portion and a second wing portion extending from an edge of the second center portion, with the second wing portion being bent in a direction away from the vent plate, and the groove may be formed between the first wing portion and the second wing portion.

The second wing portion may have a first surface facing the lower cap portion and a second surface opposite to the first surface, and the first surface may be planar, and a distance between the first surface and the second surface decreases toward an edge of the second wing portion.

Another embodiment of the present disclosure provides a cap assembly including: a vent plate; an upper cap portion arranged on a first surface of the vent plate; a lower cap portion arranged opposite to the upper cap portion with the vent plate therebetween, the lower cap including a first center portion and a first wing portion extending from an edge of the first center portion, the first wing portion being bent toward the vent plate; and a lower plate including a second center portion and a second wing portion extending from an edge of the second center portion, the second wing portion being bent in a direction away from the vent plate, and a groove is formed between the first wing portion and the second wing portion.

The second wing portion may have a first surface facing the lower cap portion and a second surface opposite to the first surface, and the first surface may be planar, and the second surface is inclined such that a distance between the first surface and the second surface decreases toward an edge fo the second wing portion.

The groove may be provided along circumferences of the lower cap portion and the lower plate.

The cap assembly may further include an insulation member surrounding an edge of the upper cap portion and an edge of the vent plate.

Another embodiment of the present disclosure provides a method of manufacturing a rechargeable battery including: accommodating an electrode assembly in an internal space of a case; recessing a part of a lateral portion of the case toward an inside of the case; and coupling a cap assembly and the case, wherein the coupling of the cap assembly and the case may include positioning the cap assembly on the recessed lateral portion of the case, coupling the cap assembly and the recessed lateral portion by pressing the cap assembly, bending an end of the lateral of the case toward the cap assembly.

The cap assembly may include a vent plate, an upper cap portion arranged on a first surface of the vent plate, a lower cap portion arranged opposite to the upper cap portion with the vent plate therebetween, and a down plate arranged adjacent to the lower cap portion, and the coupling of the cap assembly and the recessed lateral portion by pressing the cap assembly may include pressing the cap assembly until the recessed lateral portion is received in a groove provided between the lower cap portion and the down plate.

According to the present disclosure, the cap assembly may be coupled to the bead portion of the case of a rechargeable battery.

According to the present disclosure, a gasket may be omitted from a rechargeable battery.

According to the present disclosure, an operation pressure of the vent plate may increase in a rechargeable battery.

Technical objects of the present disclosure are not limited to the above-described technical objects, and other technical objects will be clearly comprehended by a person of ordinary skill in the art.

### BRIEF DESCRIPTION OF THE DRAWINGS

The drawings illustrate embodiments of the present disclosure be understood together with detailed descriptions of the present disclosure. The present disclosure is not limited to the embodiments illustrated in the drawings.

FIG. 1 is a perspective view of a rechargeable battery according to an embodiment of the present disclosure.

FIG. 2 is a cross-sectional view of the rechargeable battery with respect to a line II-II of FIG. 1.

FIG. 3 is a perspective view of a cap assembly of the rechargeable battery of FIG. 1.

FIG. 4 is a lower perspective view of the cap assembly of FIG. 3.

FIG. 5 is a cross-sectional view of the cap assembly of FIG. 3 with respect to a line V-V.

FIG. 6 is a cross-sectional view of the cap assembly according to another embodiment of the present disclosure.

FIG. 7 is a flowchart of a method for manufacturing a rechargeable battery according to an embodiment of the present disclosure.

### DETAILED DESCRIPTION OF THE EMBODIMENTS

Embodiments of the present disclosure will be described in detail with reference to the accompanying drawings. Terms or words used in the present specification and claims, which will be described below, should not be interpreted as being limited to typical or dictionary meanings, but should be interpreted as having meanings and concepts which comply with the technical spirit of the present disclosure, based on the principle that an inventor may appropriately define the concept of the terms to describe his/her own disclosure in the best manner. Therefore, configurations illustrated in the embodiments and the drawings described in the present specification are only the most preferred embodiment of the present disclosure and do not represent all of the technical spirit of the present disclosure, and thus it is to be understood that various equivalents and modified examples, which may replace the configurations, are possible if filing the present application. If used in the present specification, “comprise and include” and/or “comprising and including” may specify the existence of the mentioned shapes, numbers, steps, operations, members, elements and/or these groups, and may not exclude the presence or addition of one or more other shapes, numbers, movements, members, elements and/or groups. If embodiments of the present disclosure are described, “may perform” and “may be” may include “one or more embodiments of the present disclosure”.

To aid understanding of the disclosure, the attached drawings may not be drawn to actual scale, but the dimensions of some components may be exaggerated. The same reference number may be assigned to the same component in another embodiment.

The statement that two objects of comparison are “the same” may mean “substantially the same”. Therefore, the substantial sameness may include a case, for example, where the deviation is within 5%, which is considered low in the industry. Uniformity of a parameter in a given region may mean uniformity from an average perspective.

Although first, second, etc. are used to describe various components, the components may not be limited by these terms. These terms are only used to distinguish one component from another, and unless specifically stated to the contrary, the first component may also be the second component.

Throughout the specification, unless otherwise stated, each component may be singular or plural.

The placement of any components on an “upper portion (or a lower portion)” of a component or the “top (or bottom)” of a component may mean that any component is placed in contact with the top (or bottom) of the component. This may mean that other configurations may be interposed between and any configuration placed on (or under) the component.

It should be understood that if a component is described as “connected to” or “coupled to” another component, the components may be directly connected or accessed to each other, but other components may be “interposed” between the respective components, or the respective components may be connected, coupled, or accessed to each other through other components. If it is described that an element is “electrically coupled” to another element, the element may be directly coupled to the other element or coupled to the other element through a third element.

If it says “A and/or B” throughout the specification, it may mean A, B or A and B unless there is a special opposing statement. That is, “and/or” may include the entire combinations or arbitrary combinations of the items. If it says “C to D”, it may mean that it is higher than C and lower than D unless there is a special opposing statement.

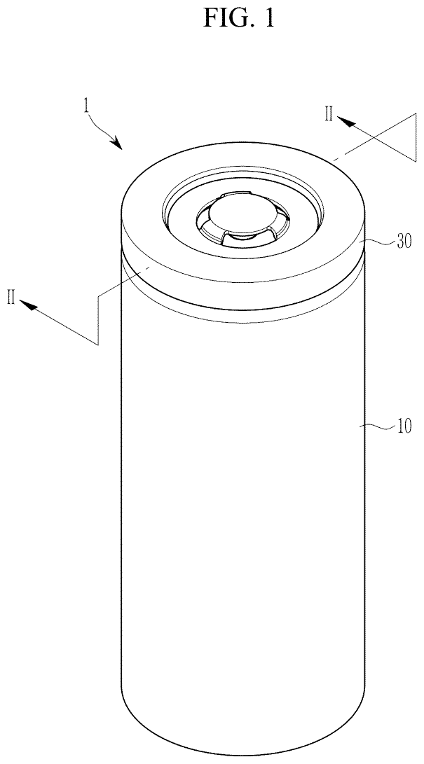

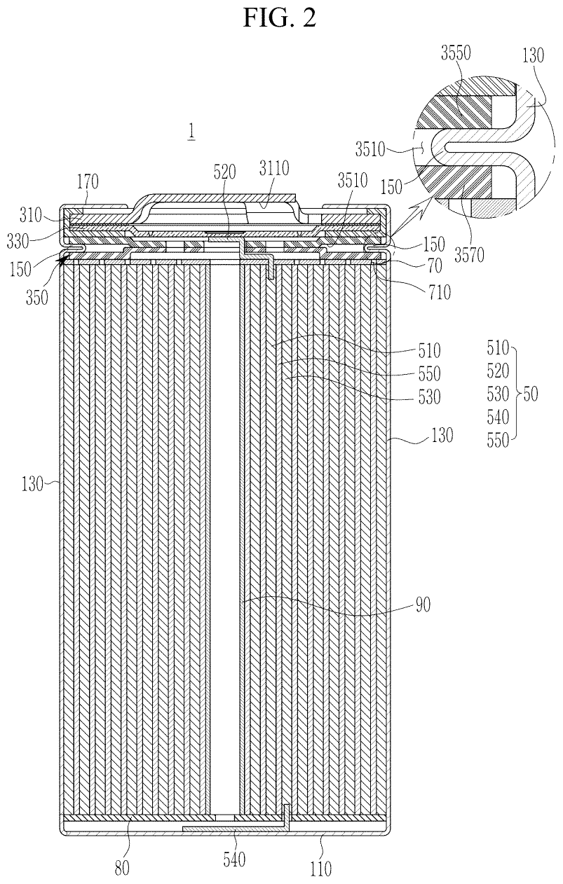

FIG. 1 is a perspective view of a rechargeable battery according to an embodiment of the present disclosure, and FIG. 2 is a cross-sectional view of t he rechargeable battery with respect to a line II-II of FIG. 1. Referring to FIG. 1 and FIG. 2, the rechargeable battery 1 may include a case 10 with an opened first side. A cap assembly 30 is coupled to the first side of the case 10, and an electrode assembly 50 is accommodated in the case 10. The electrode assembly 50 arranged in the case 10 can be isolated from the outside by a coupling of the cap assembly 30 and the case 10.

The case 10 may include a bottom portion 110. A lateral portion 130 may extend in a direction that is vertical (e.g., a vertical direction with reference to FIGS. 1 and 2) to a plane where the bottom portion 110 is disposed from an edge of the bottom portion 110. The case 10 may have an internally open structure with the first side facing the bottom portion 110 being open.

The electrode assembly 50 may be accommodated in the case 10 through the opened first side of the case 10. The lateral portion 130 of the case 10 may include a bead portion 150 recessed toward an interior of the case 10. The bead portion 150 may be disposed at a position that is above the electrode assembly 50 in the case 10. The bead portion 150 may prevent movement of the electrode assembly 50 in the length direction (e.g., the vertical direction with reference to FIG. 2).

The cap assembly 30 may be coupled to the bead portion 150. The cap assembly 30 may have a groove 3510 in which the bead portion 150 is received. With the bead portion 150 being received in the groove 3510, the position of the cap assembly 30 may be fixed. And the movement of the electrode assembly 50 in the length direction may be restricted due to the fastening of position of the cap assembly 30. A detailed description of the groove 3510 will be provided below.

The case 10 may further include a crimping portion 170 in which an end of the lateral portion 130 is bent towards an inside of the case 10. The crimping portion 170 may have a bent shape to surround at least two surfaces of the cap assembly 30. The crimping portion 170 may be disposed higher than the bead portion 150, and a portion of the crimping portion 170 may be placed on the cap assembly 30. The position of the cap assembly 30 may be further fixed by the crimping portion 170. That is, the position of the cap assembly 30 may be fixed by both the bead portion 150 and the crimping portion 170. Accordingly, the cap assembly 30 may be more firmly connected to the case 10, and the movement of the electrode assembly 50 in the height direction may be more effectively suppressed.

The cap assembly 30 may be a current interruption device (CID). The cap assembly 30 may include an upper cap portion (or cap up) 310, a vent plate 330, and a coupling portion 350.

The upper cap portion 310 may be arranged on a first surface of the vent plate 330, and through holes 3110 may be formed at a center of the vent plate. If the vent plate 330 is ruptured, gas generated in the case 10 may be discharged to the outside through the through holes 3110.

A second surface of the vent plate 330 may be placed on the first surface of the coupling portion 350. For example, the coupling portion 350 may be arranged opposite to the upper cap portion 310 with the vent plate 330 interposed therebetween.

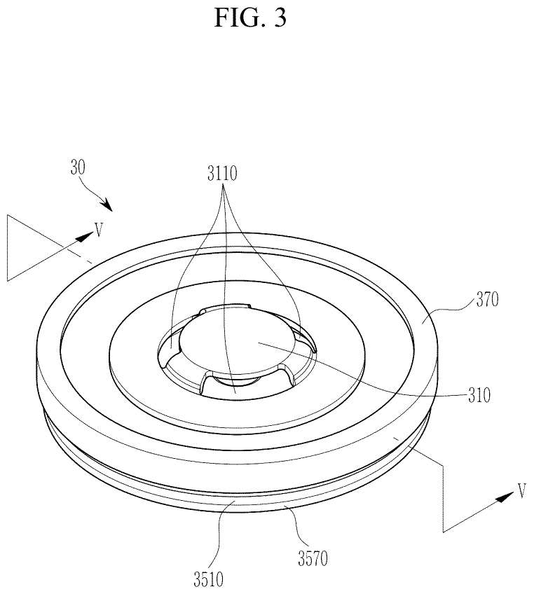

The coupling portion 350 of the cap assembly 30 may have a groove 3510. The cap assembly 30 may be coupled to the case 10 by accommodating the bead portion 150 in the groove 3510. A detailed description on the cap assembly 30 will be provided below with reference to FIG. 3 to FIG. 5.

The electrode assembly 50 may include a first electrode 510, a second electrode 530, and a separator 550 disposed between the electrodes 510 and 530. The electrode assembly 50 may be formed by stacking first electrode 510, the separator 550, and the second electrode 530 and then winding the stacked structure.

The first electrode 510 and the second electrode 530 may each be either a positive electrode or a negative electrode, and the first electrode 510 and the second electrode 530 may have different polarities. For example, if the first electrode 510 is a negative electrode, then the second electrode 530 may be a positive electrode, and if the first electrode 510 is a positive electrode, then the second electrode 530 may be a negative electrode. In the present disclosure, the first electrode 510 will be referred to as a positive electrode and the second electrode 530 will be referred to as a negative electrode.

The positive electrode may include a positive electrode composite layer in which a positive electrode active material (e.g., transition metal oxides (LiCoO2, LiNiO2, LiMn2O4, etc.)) is coated on a positive electrode current collecting plate. The negative electrode may include a negative electrode composite layer in which a negative electrode active material (e.g., graphite, carbon, etc.) is coated on a negative electrode current collecting plate. The negative electrode current collecting plate may be a copper (Cu) foil, and the positive electrode current collecting plate may be an aluminum (Al) foil. But the present disclosure is not limited to current collecting plates made from these materials.

The separator 550 may prevent electric short-circuit by prevent contact between the first electrode 510 and the second electrode 530 and may allow the movement of ions (e.g., lithium (Li) ions). The separator 550 may be made of a polyethylene (PE) film, a polypropylene (PP) film, etc.

The electrode assembly 50 may further include a first electrode tab 520 electrically connected to the first electrode 510 and a second electrode tab 540 electrically connected to the second electrode 530. In an embodiment of the present disclosure, the first electrode tab 520 may function as a positive electrode tab and may be made of aluminum (Al), and the second electrode tab 540 may function as a negative electrode tab and may be made of copper (Cu) or nickel (Ni).

The first electrode tab 520 may protrude toward the cap assembly 30 from the first electrode 510. The second electrode tab 540 may protrude toward the bottom portion 110 of the case 10 from the second electrode 530. However, the protruding directions of the first electrode tab 520 and the second electrode tab 540 are not limited to such an arrangement.

The first electrode tab 520 may be electrically connected to the vent plate 330 through the first insulation plate 70, which is placed on the wound electrode assembly 50. The first insulation plate 70 may have a penetration hole 710 through which the first electrode tab 520 passes. Multiple penetration holes 710 may be provided, and the first electrode tab 520 may pass through one of the penetration holes 710.

The second electrode tab 540 may be electrically connected to the bottom portion 110 through the second insulation plate 80 disposed between the electrode assembly 50 and the bottom portion 110. The case 10 may have the polarity of the second electrode 530 (e.g., negative).

The rechargeable battery 1 may further include a center pin 90 disposed at the wound center of the electrode assembly 50. The center pin 90 may be a hollow circular pipe, may suppress deformation of the electrode assembly 50 due to repeated charging and discharging, and may form a passage for gas generated in the rechargeable battery 1.

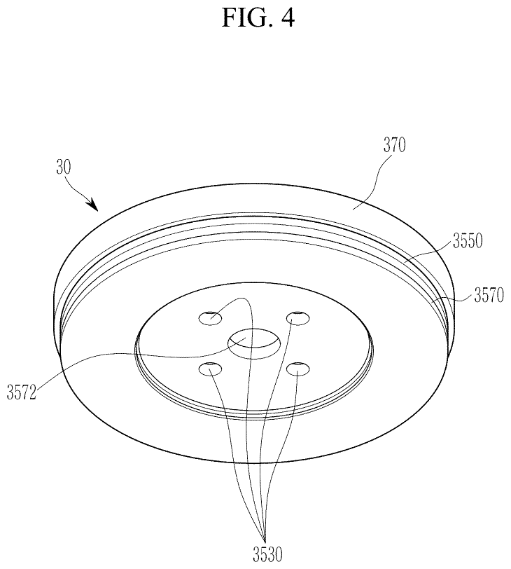

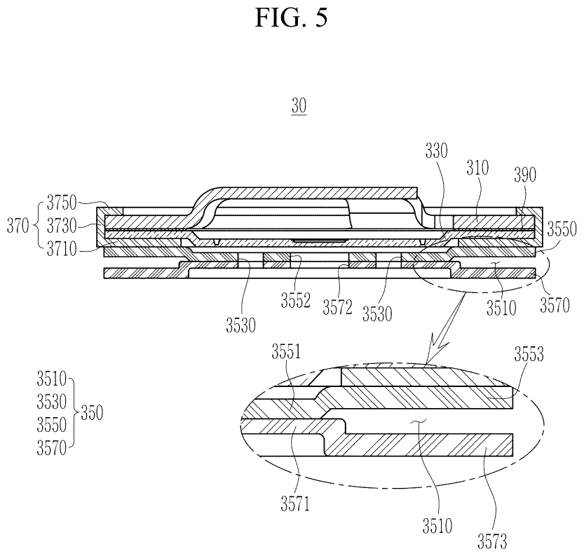

FIG. 3 shows a perspective view of a cap assembly 30 of a rechargeable battery 1 of FIG. 1, FIG. 4 shows a lower perspective view of a cap assembly 30 of FIG. 3, and FIG. 5 shows a cross-sectional view of a cap assembly 30 of FIG. 3 with respect to a line V-V.

Referring to FIG. 3 to FIG. 5, the cap assembly 30 may further include an insulation member 370 disposed between the vent plate 330 and the coupling portion 350. The insulating member 370 may prevent the movement of electrons between the vent plate 330 and the coupling portion 350. That is, the insulation member 370 may prevent an electric short-circuit between the first electrode 510 (see FIG. 2) and the second electrode 530 (see FIG. 2).

The insulation member 370 may have a configuration in which its first side is extended and is bent to surround at least two surfaces of the upper cap portion 310. For example, the extended first side of the insulation member 370 may be bent in the height direction of the cap assembly 30 (e.g., vertical direction with reference to FIG. 5) and then bent toward the center of the cap assembly 30. Further details of the insulation member 370 will be provided below.

The coupling portion 350 may include a lower cap portion (or cap down) 3550 and a lower plate (or down plate) 3570. The lower cap portion 3550 may be placed between the lower plate 3570 and the vent plate 330. An insulation member 370 may be interposed between the lower cap portion 3550 and the vent plate 330. The lower cap portion 3550 and the down plate 3570 may be coupled, for example, using adhesive.

The lower cap portion 3550 may have a first opening 3552, and the down plate 3570 may have a second opening 3572 corresponding to the first opening 3552. The first opening 3552 and the second opening 3572 may align with each other and form a passage for the first electrode tab 520 to pass. The first electrode tab 520 may be electrically connected to the vent plate 330 through the first opening 3552 and the second opening 3572.

Each of the lower cap portion 3550 and the down plate 3570 may have vent holes 3530 arranged around the first opening 3552 and the second opening 3572. Gas generated in the electrode assembly 50 (see FIG. 2) may move into the cap assembly 30 through the vent hole 3530.

If the first electrode tab 520 is electrically connected to the vent plate 330, the vent plate 330 may react more sensitively to temperature changes of the electrode assembly 50. Therefore, if the temperature of the electrode assembly 50 rises above a threshold value, the vent plate 330 may react to this and may be broken, thereby blocking the current between the first electrode tab 520 and the cap assembly 30. That is, by directly connecting the first electrode tab 520 to the vent plate 330, the vent plate 530 may have more sensitive reactivity, and the stability of the rechargeable battery 1 may be improved.

The lower cap portion 3550 may include a first center portion 3551 and a first wing portion 3553 extended from an edge of the first center portion 3551. The first wing portion 3553 may be bent toward a direction (e.g., the upper direction with reference to FIG. 5) in which the vent plate 330 is disposed.

The lower plate 3570 may include a second center portion 3571 and a second wing portion 3573 extended from an edge of the second center portion 3571. The second wing portion 3573 may be bent toward a direction (e.g., the downward direction with reference to FIG. 5) opposite to the direction in which the vent plate 330 is disposed. The directions that the first wing portion 3553 and second wing portion 3573 are bent are different from each other so that the first wing portion 3553 is spaced apart from the second wing portion 3573. As such, a groove 3510 may be provided between the first wing portion 3553 and the second wing portion 3573. FIG. 2 shows further details of the coupling relationship between the cap assembly 30 and the case 10.

The groove 3510 may accommodate the bead portion 150, and if the bead portion 150 is accommodated in the groove 3510, the cap assembly 30 may be coupled to the case 10 so that its position may be fixed.

Some components (e.g., the lower cap portion 3550, the down plate 3570, etc.) of the cap assembly 30 may be disposed in an internal space of the case 10 in a line with the bead portion 150. Thus, the internal space of the case 10, which is narrowed due to the bead portion 150, may also be easily used. That is, the internal space of the rechargeable battery 1 may be used more efficiently with the arrangement disclosed herein.

Further, the cap assembly 30 is placed in the internal space of the case 10 due to the bead portion 150, the position of the bead portion 150 may become higher than in other rechargeable batteries. Accordingly, a length of the bead portion 150 that is equal to or shorter than the lateral portion 130 of the case 10 may be increased compared to a conventional example, thereby increasing the space for accommodating the electrode assembly 50. As the space accommodating the electrode assembly 50 of the case 10 increases, the volume of the accommodated electrode assembly 50 may increase. And, as a result, the energy capacity of the rechargeable battery 1 is increased.

As the bead portion 150 is accommodated in the groove 3510, the position of the cap assembly 30 may be fixed more stably, so the vent plate 330 of the cap assembly 30 may withstand higher pressure. As such, there is an increase in an operating pressure (or a breaking pressure) for the vent plate.

The lower plate 3570 may be made of an elastic and insulative material. The lower plate 3570 may be plastic having both elasticity and insulating properties. For example, the lower plate 3570 may be polyethylene or polypropylene. Regarding the lower plate 3570, the second wing portion 3573 may be made of the same material as the above. When the lower plate 3570 is made of an elastic material, and if the cap assembly 30 is coupled to the bead portion 150 of the case 10, a portion of the second wing portion 3573 contacting the bead portion 150 may be easily bent. Thus, the second wing portion 3573 may easily pass through the bead portion 150. That is, the cap assembly 30 may be easily coupled to the case 10 due to the elasticity of the second wing portion 3573.

The lower plate 3570 is insulative so it may prevent the current flowing from the first electrode tab 520 from being transmitted to the lateral portion 130 of the case 10. That is, the second wing portion 3573 may prevent the electrical connection between the case 10 and the first electrode tab 520 due to its insulating property, thereby improving stability of the rechargeable battery 1.

The elasticity of the lower plate 3570 may be stronger than the elasticity of other components of the cap assembly 30. For example, the lower cap portion 3550 may have elasticity, and the elasticity of the lower plate 3570 may be stronger than the elasticity of the lower cap portion 3550. This facilitates the combination of the cap assembly 30 and the case 10, while preventing detachment of the cap assembly 30 from the case 10.

The cap assembly 30 may further include an insulation member 370 disposed between the vent plate 330 and the coupling portion 350. The insulation member 370 may include a first portion 3710 disposed between the vent plate 330 and the lower cap portion 350 and a second portion 3730 connecting the first portion 3710 and a third portion 3750, with the third portion 3750 being disposed on the upper cap portion 310. That is, a first side of the second portion 3730 may be connected to the first portion 3710 and a second side of the second portion 3730 may be connected to the third portion 3750.

The second portion 3730 may be in contact with the sides of the vent plate 330 and the upper cap portion 310. If the cap assembly 30 is coupled to the case 10, the second portion 3730 may be disposed between the lateral portion 130 of the case 10 and the vent plate 330 (or the upper cap portion 310) to insulate between the cap assembly 30 and the case 10.

The case 10 may have the same polarity as the second electrode 530 as described above. The vent plate 330 of the cap assembly 30 may be electrically connected to the first electrode tab 520 and may thereby have the same polarity as the first electrode 510. Thus, the insulation member 370 may prevent electric short-circuit by separating the cap assembly 30 and the case 10, which have different polarities, through the second portion 3730. The rechargeable battery 1 includes an insulation member 370 having a second portion 3730 does not need to include a component (e.g., a gasket) for providing insulation between the case 10 and the cap assembly 30. Accordingly, when using the cap assembly 30 of the rechargeable battery 1 as described herein, production cost may be reduced by omitting components such as a gasket, the weight of the cap assembly 30 may also be reduced, and manufacturing of a rechargeable battery may become easier.

The third portion 3750 extending to the second side from the second portion 3730 of the insulation member 370 may be disposed between the upper cap portion 310 and the crimping portion 170. For example, the third portion 3750 may be placed on the upper cap portion 310, and some components of the cap assembly 30, which are laminated together with the first portion 3710 and the second portion 3730, may be pressed from three sides (e.g., the top, bottom, and side) to fix the laminated state. Thus, the mechanical stability of the cap assembly 30 may be improved by the third portion 3750.

A positive thermal coefficient (PTC) element 390 may be placed between the upper cap portion 310 and the vent plate 330. A first surface of the PTC element 390 may contact the edge of the vent plate 330, and a second surface of the PTC element 390 may contact the edge of the upper cap portion 310. The PTC element 390 may increase its resistance as the temperature increases. Accordingly, if a thermal event occurs in the rechargeable battery 1 and the temperature of the rechargeable battery 1 increases, the temperature of the PTC element 390 may also increase, causing the resistance to increase. And the PTC element 390 may block the current between the vent plate 330 and the upper cap portion 310 as its resistance increases.

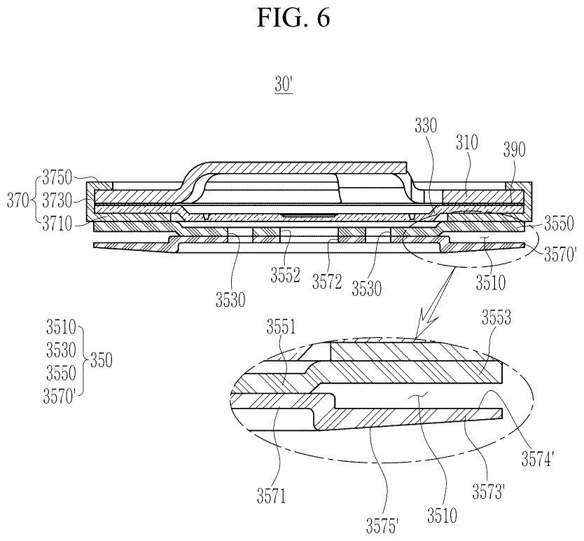

FIG. 6 shows a cross-sectional view of a cap assembly 30′ according to another embodiment of the present disclosure. Referring to FIG. 6, a second wing portion 3573′ of a lower plate 3570′ may be inclined. The second wing portion 3573′ may be sloped so that the thickness becomes thinner towards the edge. For example, the second wing portion 3573′ may have the shape of an inverted right triangle. As one example, the second wing portion 3573′ may have a structure in which a first surface 3574′ facing the lower cap portion 3550 is flat and a second surface 3575′ facing the first surface 3574′ is inclined. In a direction toward the edge of the second wing portion 3573′, the first surface 3574′ and the second surface 3575′ may become closer to each other.

The second surface 3575′ having an inclined structure may reduce friction between the cap assembly 30′ and the bead portion 150 during coupling and may induce insertion direction and alignment of the cap assembly 30′ to thereby facilitate alignment of the coupled position of the cap assembly 30′. The first surface 3574′ having a flat structure may provide increased friction between the first surface 3574′ and the bead portion 150 after coupling the cap assembly 30 and the bead portion 150, which thereby prevents detachment of the cap assembly 30′. Thus, due to the shape of the second wing portion 3573′, the cap assembly 30′ may be more easily coupled to the case 10, and the combination may be maintained more firmly.

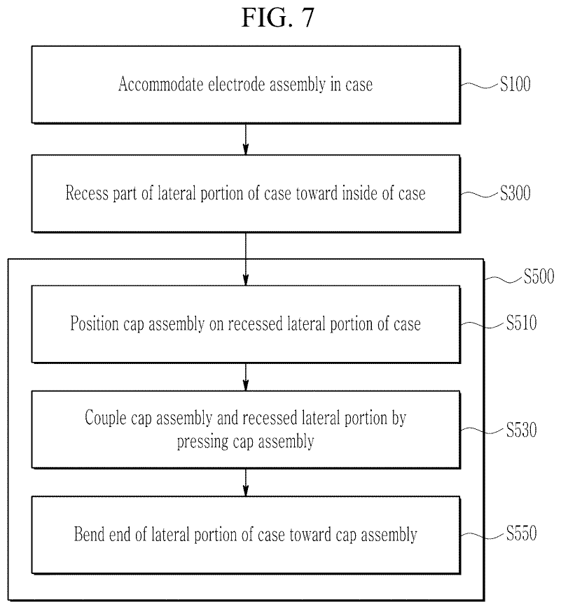

FIG. 7 shows a flowchart of a method of manufacturing a rechargeable battery according to an embodiment of the present disclosure. Referring to FIG. 7, the method of manufacturing a rechargeable battery may include accommodating an electrode assembly in a case (S100). In this step, a wound electrode assembly may be inserted through the opened first side of the case.

The method may further include recessing a part of a lateral portion of the case toward an inside of the case (S300). The electrode assembly may be accommodated in the case, and a portion of the lateral portion of the case that is disposed above the electrode assembly may be recessed into the case. Through the above process, the recessed lateral portion (e.g., a bead portion) of the case may be provided, and the recessed lateral portion and the electrode assembly may not be in contact with each other.

The method may further include coupling the cap assembly to the case (S500). The coupling of the cap assembly to the case of S500 may include positioning the cap assembly on a recessed lateral portion of the case (S510). The cap assembly may be inserted through the opened first side of the case, and the second wing portion of the lower plate may be seated on the bead portion.

The coupling of the cap assembly to the case S500 may further include coupling the cap assembly to the recessed lateral portion by pressing the cap assembly (S530). The cap assembly may be pressed until the second wing portion passes through the bead portion, and the bead portion is accommodated in the groove provided between the lower cap portion and the down plate. Accordingly, the cap assembly may be coupled to the recessed lateral portion (or bead portion) of the case and its position may be fixed.

By coupling the cap assembly with the bead portion, the cap assembly may occupy the internal space of the case between the bead portions. Thus, the case may be configured such that the bead portion is positioned a higher position than prior art. Thus, the internal space of the case accommodating the electrode assembly may be increased. And as the internal space is increase, so to may the volume of the accepted electrode assembly be increased. As a result, the rechargeable battery may have increased energy capacity.

The position of the cap assembly may be stably fixed due to the combination of the cap assembly and the bead portion so the cap assembly may better withstand the pressure generated inside the rechargeable battery and thus may avoid being detached. Accordingly, the operating pressure of the vent plate of the cap assembly may increase.

The coupling the cap assembly to the case in S500 may further include bending an end of the lateral portion of the case toward the cap assembly (S550). That is, the case may be finished by bending the lateral end portion of the case in a direction that proceeds to the cap assembly while the cap assembly is coupled to the bead portion. Thus, the cap assembly may be fixed by additional a crimping work.

In conventional batteries, the cap assembly is placed on the bead portion and multiple crimping operations are performed to fix the position of the cap assembly. However, the method of manufacturing a rechargeable battery according to an embodiment of the present disclosure may fix the position of the cap assembly by performing one crimping operation. Thus, the manufacturing time may be shortened and the method may be made easier.

While this disclosure has been described in connection with what is presently considered to be practical exemplary embodiments, it is to be understood that the disclosure is not limited to the disclosed embodiments. Rather various modifications and equivalent arrangements are included within the spirit and scope of the present disclosure.

<Description of symbols>

| | |
|---|---|
| 1: rechargeable battery | 10: case |
| 30: cap assembly | 50: electrode assembly |
| 70: first insulation plate | 80: second insulation plate |
| 90: center pin | 110: bottom portion |
| 130: lateral portion | 150: bead portion |
| 170: crimping portion | 310: upper cap portion |
| 330: vent plate | 350: coupling portion |
| 370: insulation member | 390: PTC element |
| 510: first electrode | 520: first electrode tab |
| 530: second electrode | 540: second electrode tab |
| 550: separator | 710: penetration hole |
| 3110: through hole | 3510: groove |
| 3530: vent hole | 3550: lower cap portion |
| 3551: first center portion | 3552: first opening |
| 3553: first wing portion | 3571: second center portion |
| 3572: second opening | 3573: second wing portion |
| 3574′: first surface | 3575′: second surface |
| 3710: first portion | 3730: second portion |
| 3750: third portion | |
| S100: Accommodate electrode assembly in | |
| case | |
| S300: recess part of lateral portion of case | |
| toward inside of case | |
| S500: Combine cap assembly to case | |
| S510: Insert cap assembly into case | |
| S530: Combine cap assembly to recessed | |
| lateral portion by pressing cap assembly | |
| S550: Bend lateral end portion of case in | |
| direction proceeding to cap assembly | |

What is claimed is:

1. A rechargeable battery comprising:
a case comprising a bottom portion, a lateral portion extending from an edge of the bottom portion, with the lateral portion including a bead portion that is recessed toward an inside of the case;
an electrode assembly accommodated in the case, the electrode assembly comprising a first electrode, a second electrode, and a separator disposed between the first electrode and the second electrode; and
a cap assembly coupled to the case,
wherein the cap assembly comprises:
a vent plate,
an upper cap portion arranged on the vent plate, and
a coupling portion arranged opposite to the upper cap portion with the vent plate therebetween, the coupling portion including a groove in which the bead portion is received.

2. The rechargeable battery as claimed in claim 1, wherein the coupling portion comprises:
a lower cap portion; and
an elastic lower plate
wherein the groove is formed by the lower cap portion and the lower plate.

3. The rechargeable battery as claimed in claim 2, wherein the lower plate is more elastic than the lower cap.

4. The rechargeable battery as claimed in claim 3, wherein the lower plate is made of polyethylene (PE) or polypropylene (PP).

5. The rechargeable battery as claimed in claim 2, wherein a first opening is formed in the lower cap,
wherein a second opening is formed in the lower plate, with the second opening being aligned with the first opening, and
wherein a first electrode tab electrically connected to the first electrode passes through the first opening and the second opening and is electrically connected to the vent plate.

6. The rechargeable battery as claimed in claim 1, wherein the cap assembly further comprises an insulation member for preventing electric short-circuit between the first electrode and the second electrode, and
wherein the insulation member comprises:
a first portion arranged between the vent plate and the lower cap portion, and
a second portion having a side connected to the first portion, with the second portion being arranged between the vent plate and the lateral portion.

7. The rechargeable battery as claimed in claim 6, wherein the case further comprises a crimping portion at an end of the lateral portion, the crimping portion being bent toward the cap assembly, and
wherein the insulation member further comprises a third portion connected to a second side of the second portion and arranged between the upper cap portion and the crimping portion.

8. The rechargeable battery as claimed in claim 2, wherein the lower cap portion comprises a first center portion and a first wing portion extending from an edge of the first center portion, the first wing portion being bent in a direction toward the vent plate,
wherein the lower plate comprises a second center portion and a second wing portion extending from an edge of the second center portion, the second wing portion being bent in a direction away from the vent plate, and
wherein the groove is formed between the first wing portion and the second wing portion.

9. The rechargeable battery as claimed in claim 8, wherein the second wing portion has a first surface facing the lower cap portion and a second surface opposite to the first surface, and
wherein the first surface is planar, and a distance between the first surface and the second surface decreases toward an edge of the second wing portion.

10. A cap assembly comprising:
a vent plate;
an upper cap portion arranged on a first surface of the vent plate;
a lower cap portion arranged opposite to the upper cap portion with the vent plate therebetween, the lower cap including a first center portion and a first wing portion extending from an edge of the first center portion, the first wing portion being bent toward the vent plate; and
a lower plate comprising a second center portion and a second wing portion extending from an edge of the second center portion, the second wing portion being bent in a direction away from the vent plate,
wherein a groove is formed between the first wing portion and the second wing portion.

11. The cap assembly as claimed in claim 10, wherein the second wing portion has a first surface facing the lower cap portion and a second surface opposite to the first surface, and
wherein the first surface is planar, and the second surface is inclined such that a distance between the first surface and the second surface decreases toward an edge of the second wing portion.

12. The cap assembly as claimed in claim 10, wherein the groove provided along circumferences of the lower cap portion and the lower plate.

13. The cap assembly as claimed in claim 10, further comprising an insulation member surrounding an edge of the upper cap portion and an edge of the vent plate.

14. A method of manufacturing a rechargeable battery comprising:
accommodating an electrode assembly in an internal space of a case;
recessing a part of a lateral portion of the case toward an inside of the case; and
coupling a cap assembly and the case,
wherein the coupling of the cap assembly and the case comprises:
positioning the cap assembly on a recessed lateral portion of the case,
coupling the cap assembly and the recessed lateral portion by pressing the cap assembly, and
bending an end of the lateral portion of the case toward the cap assembly.

15. The method as claimed in claim 14, wherein the cap assembly comprises a vent plate, an upper cap portion on a first surface of the vent plate, a lower cap portion arranged opposite to the upper cap portion with the vent plate therebetween, and a lower plate arranged adjacent to the lower cap portion, and
wherein the coupling of the cap assembly and the recessed lateral portion by pressing the cap assembly comprises pressing the cap assembly until the recessed lateral portion is received in a groove provided between the lower cap portion and the down plate.
